(19) United States
(12) Patent Application Publication
(10) Pub. No.: US 2003/0078835 A1
(43) Pub. Date: Apr. 24, 2003

(54) METHOD OF ESTABLISHING A PROMOTION AT A POINT OF SALE TERMINAL

(76) Inventor: TODD KENDAL PLUCHINSKE, HEADINGLEY (CA)

Correspondence Address: SHAPIRO COHEN, P.O. BOX 3440, STATION D, OTTAWA, ON, K1P6P1, CA

(21) Appl. No.: 09/404,305

(22) Filed: Sep. 24, 1999

(51) Int. Cl. G06F 17/60

(52) U.S. Cl. 705/14; 705/17

(57) ABSTRACT

A method of operating an electronic promotion system, generating a database which tracks usage of marketing and advertising programs and allows for full audit capability. The method comprises inputting the identity of a promotion program, generating a unique identifier relating to the identity inputted and a transaction associated with the inputting, storing the unique identifer and the identity of the promotion in a database and authorizing provision of the promotion at the database.

### FIELD OF THE INVENTION

This invention relates to a method of establishing a promotion such as a discount or prize at a point of sale terminal.

### BACKGROUND TO THE INVENTION

An important part of marketing and advertising programs for some companies is capture of the attention of customers at the point of sale, and to positively influence their buying decisions. A widely used method of influencing customer behavior at the point of sale is to offer promotional programs that provide the customer with the opportunity, for example, to win a prize or to receive a variable discount at the time of purchase. Scratch and win or scratch and save promotional games are examples of this type of marketing program.

However, the effectiveness of these programs for companies is limited by their cost. A significant amount of money must be invested in the production of scratch cards that cannot be cheated, in distributing these cards to individual households in a trading area, tracking the redemption of the cards at the retail level, and compiling of data that measures the effectiveness of the programs. Because costs have been found to be so high, the most effective point of sale marketing and advertising programs have been limited to larger organizations which have the resources to effectively implement them.

### SUMMARY OF THE INVENTION

The present invention substantially reduces the high cost of running marketing and advertising programs at the point of sale. The present invention generates a database which tracks usage of the programs, which allows full audit capability. It combines both delivery and redemption of a promotion at any terminal associated with the system. It can vary the value or form of promotion that is provided to the customer, which can be tailored to the number or values of redemptions of particular types, the identities and/or purchase histories of customers asking for or being offered promotions or redemptions, the odds of winning a particular prize or class of prizes, it can use the element of chance with controllable and variable odds to award a prize, etc. Because promotions can be stored in a memory, requests for redemption can be compared with what is stored, and thus substantially reduce the risk of fraud. The identities and/or demographics of customers who use the system can be stored and associated with the promotions and redemptions, and thus the promotions can be tailored to maximize influence of purchasing decisions by the customers.

It is particularly noted that the promotions can be automatically offered on a chance basis at the point of sale terminal.

Record of all of the above is automatically gathered and stored in the database, which can be accessed on an ongoing basis or from time to time for evaluation purposes. The cost of operation of the promotion and redemption programs is thereby substantially reduced.

The invention can be used in conjunction with marketing and advertising programs of several companies, using a single database or several databases stored on a single server or on plural servers which are in communication with each other and/or with commonly available point of sale terminals, and thus it can be operated by an independent operator which sells its services to various companies for various promotions.

In accordance with an embodiment of the invention a method of operating an electronic promotion system is comprised of inputting at a terminal the identity of a promotion, generating an unique identifier relating to at least one of the inputting of said identity and a transaction associated with said inputting of said identity, storing the identity of the promotion and the unique identifier in a database, and authorizing provision of the promotion at the terminal, whereby at least one of the identity of promotions, the number of requests for access to promotions and the number of promotions authorized to be redeemed may be retrieved from the database for assessment on an ongoing or accumulated basis.

In accordance with another embodiment, a method of operating an electronic promotion system is comprised of at a terminal, generating a request to a promotion awarding process, receiving the request and generating a promotion based on at least one of chance, a predetermined algorithm, values input at the terminal, and the existence of a predetermined fixed promotion, and authorizing provision of the generating promotion at a terminal.

### BRIEF INTRODUCTION TO THE DRAWINGS

A better understanding of the invention may be obtained by reading the detailed description of the invention below, in conjunction with the following drawings, in which:

FIG. 1 is a block diagram of a system on which the invention can be carried out.

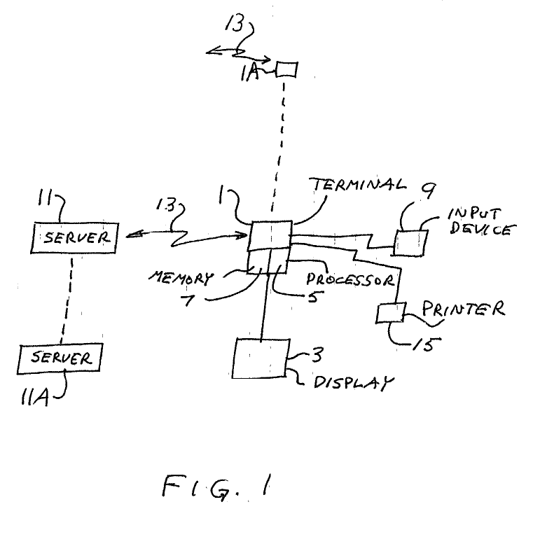

### DETAILED DESCRIPTION OF EMBODIMENTS OF THE INVENTION

Point of sale processor controlled terminals 1 are located at various locations, such as at retail locations. The respective terminals can be based on a personal computer, a computerized cash register, a credit/debit card authorization terminal such as a VeriFone Omni 396 transaction terminal, etc. The terminal should have an output device by which it can advise users with visual or voice information, such as a display, a printer, a loudspeaker for providing audio information, etc. All these output devices will be referred to generically herein as a display 3, which is driven by the terminal 1.

The terminal, besides having a processor 5, should have memory 7 controlled by the processor 5.

An input device 9 is in communication with, or is part of the terminal, and should be a well known type which can capture numbers and symbols. For example, the input device can be one or more of a keypad, a touch-screen, a microphone which captures spoken numbers and software in the terminal which interprets the spoken numbers, a bar code or number scanner, etc.

The input and output devices and the terminal itself could alternatively be an interactive voice response system located on a remote computer, and which is accessed by telephone.

The terminal is preferably in communication with a server 11 via a communication link 13, which could be a local area network, a wide area network, a telephone network, a CATV system, a satellite link, a radio transmission link, etc. The server can be located either locally to one or more terminals, or remote from the terminals.

The server can be in communication with other servers 11A that are located at various geographic locations. One of the servers, or an administrative terminal (not shown), can be located at a head office, from which databases at the servers can be accessed and the information stored therein be downloaded, either already compiled by one or all of the servers, for local compiling, or for reading by an administrator.

It is preferred (but is not mandatory) that a printer 15 is in communication with, and is controlled by the terminal 1 if the server is remotely located, or by the server if it is locally located.

In operation, a potential customer is encouraged to visit a particular retailer or other location of a terminal 1. The encouragement can be by distribution of a printed piece in the form of a discount coupon or free standing insert, a PIN or unique sequence of numbers if radio or television is used, a mailing of a promotional flyer, card coupon or form, a piece printed by the customer after having accessed a particular internet site and which carries a PIN or unique sequence of numbers, etc., any of which designate a particular retailer or class of retailers from which a promotion can be redeemed. Alternatively, adverting may simply encourage a visit to the location of a terminal to ask for a particular promotion by name.

Wherever possible, and in particular in the case in which the internet is used to deliver the media campaign, visiting a site which hosts the campaign may require entry of personal information and/or a PIN. These pieces of information are subsequently used to associate personal information with the campaign. The pieces of information may be stored on a server which is associated with the company providing the campaign. It may also be stored in the memory of an integrated circuit chip contained on a so-called “smart card” carried by the user.

The user may download from the internet and print a promotional coupon or other piece, which preferably carries an unique bar code, sequence of numbers, and/or other data which identifies the promotion, and possibly the user uniquely or as part of a group (e.g. conforming to particular demographics). Other promotional literature which a user can access from time to time (e.g. from a magazine, newspaper, mail delivery, etc.) can identify the user as part of a group, and identify the promotion by bar code, a sequence of numbers, etc.

The server 11 should store sequences identical to those printed on the promotional literature or coupon.

In operation, a customer attends a terminal 1 and typically makes a purchase. If purchasing by credit card, debit card or smart card, the card is swiped or is otherwise read by an input device at the terminal. In this manner, the identity of the purchaser is captured and is retained in the memory 7 of the terminal. Software in the memory of the terminal is used by the processor to control dialing out to obtain authorization for the transaction, in a well known manner.

In accordance with an embodiment of the present invention, software in the terminal 1 causes the processor 5 to display a menu or the equivalent by display 3 which lists various promotions, and asks whether the transaction is associated with a particular promotion which is listed. Each promotion which is displayed should be selected e.g. by number, by selection by a cursor, by highlighting the promotion, by voice enunciation, by touch screen, etc.

If the selected promotion has a required printed piece associated with it, the processor should cause display of a request that the piece should be scanned, or that the unique number should be entered by keypad or touch screen. If the customer has no printed piece, but does have a PIN from a broadcast or internet campaign, the prompt should request that the PIN should be entered by keypad or touch screen.

If the promotion is a scratch and win or save type of promotion, the prompt should request that the appropriate number or series of numbers should be selected from the piece.

As these steps are being completed, the terminal captures and stores in memory 7 the swiped or read credit/debit/smart card data associated with the user and all of the entries by the user in response to the prompts. When all of the required entries have been completed, the processor controls the terminal to communicate with server 11 (e.g. by automatically dialing the server via a telephone network), and uploads the information to the server.

The server attempts to identify the user from the information which is uploaded, as provided by the credit/debit/smart card. If it does, this means that there was already a database file generated as a result of at least one previous transaction of this type by the user, or as a result of information stored on the server from that provided by an internet site or an associated bank or other entity.

Optionally, if the customer is identified, it may send a command to the terminal to display a request for the customer to enter a PIN, for certainty of identification. In this case, after or during entry of the PIN, it is uploaded to the server.

The identity of the promotion and optionally of the active terminal is then stored in the database in association with the customer.

In the event the customer is not identified, a new database record is created by the server, which stores the customer identification, identification of the promotion, and optionally the terminal.

It is possible that the customer cannot be automatically identified, due to having paid for the purchase in cash. In that case (and preferably in all cases), the transaction is recorded at the server under a number uniquely allocated by the server for that transaction. The promotion identification code and the unique transaction number is recorded in a general transaction record in the database.

Entry of the above data to the server can be considered to be a request for redemption of a promotion which has been offered by the aforenoted printed or broadcast advertising, on the internet, or at the point of sale terminal. The server can record the request for redemption as a count for the particular promotion identified in the uploading, can record the request against the identified requester, etc.

Now the server can respond to the request by either of several steps.

It can authorize exact fulfilment of the promotion by the terminal. In this case it should send an authorization code or specific commands to the requesting terminal, which causes display of the premium, discount, prize, etc. to be given to the customer, and preferably printout of a ticket with the identifying transaction number.

It can access the database relating to the identified customer to determine how many or what value of purchases the customer has made which the system has recorded. It can then adjust the promotional award, e.g. by increasing a discount with increase in purchase value or frequency of purchase. It should then send an authorization code or specific commands to the requesting terminal identifying the promotional award.

It can compare data such as numbers keyed in from a scratch and win or save card with numbers stored in its memory, to determine whether the numbers are legitimate, and in order to further reduce fraud, compare the numbers scanned from a bar code or otherwise imprinted on the card with a corresponding code stored in the server memory against winning numbers, and reject the request if they do not match. It can also award a value or type of premium depending on the particular set of numbers provided.

It can compare numbers input by the user which are acquired by contest, skill, or provided by an internet site or at a retailer or other supplier (which may have been randomly selected), with a set of numbers stored by the server, and reject the request if they do not match. It can also award a value or type of premium depending on the particular set of numbers provided.

It can send a message to the terminal to display a request for the user to verify the numbers that have been input, again to help avoid fraud. It can alternatively or in addition, cause display of the numbers that have been input, to obtain approval of the numbers by the user by input of “yes/no” at the terminal.

It can compare the requested promotion redemption with previous redemptions to determine whether the values or characters of the redemptions are becoming excessive with respect to a particular criterion or to various criteria. For example, if the promotion had initially been determined to allocate quantities or values of premiums or awards in increasing number with decreasing value, and if the number of requests for redemption become excessive for a particular value, based on a predetermined algorithm, the system may reject the request for redemption or may substitute other types of prizes, premiums, discounts, etc., so that promoter would not lose money. Indeed, if excessive requests for redemption from a particular identified user is detected by the algorithm (e.g. in excess of a particular threshold), there may be fraud which was not detected by the other methods described above, and the system may send a message to the terminal to refuse further redemption to that identified user.

The data which is uploaded to the server may not contain data identifying a particular promotional value. In this case the server may randomly, or in accordance with a particular algorithm, determine a prize such as a discount, premium, etc, and download a command to the terminal to display information identifying the prize. The algorithm can take into account time of day, identity and history of the customer (if the identity has been provided), the history of the terminal, the overall success of the campaign, how many of particular types and/or values of prizes have been awarded, the type of purchase, etc. In such cases, the incentive for the customer to make the purchase would be to participate in what appears to be an electronic “lucky draw”.

The server may download commands to the terminal causing it to display a game, such as a request for the customer to select one or a group of numbers out of a larger group. The winning numbers can be randomly determined by the server prior to, during or following selection by the customer. Alternatively, the winning numbers can be determined by the server in accordance with an algorithm. Further, the character of and value of the prize can be determined either randomly, in accordance with a predetermined algorithm, past history of the game or it can be present.

Once a set of numbers has been selected and uploaded to the server, it selects identifiers of a running set of numbers and prize and downloads a command to the corresponding terminal to display information regarding the prize.

Any other appropriate game, rather than the numbers game described above, may be implemented in an analogous manner.

Alternatively, simply making the purchase or otherwise attending at the terminal and uploading the data described earlier to the server, can cause the server to select that data transaction as a winner or loser by chance, by algorithm, by other selection, etc., without the user having a menu displayed or having to select numbers or play a game.

Rather than downloading a game, the server can download to the terminal an application engine which is capable of generating data that can be used to create a game upon receipt of a set of instructions downloaded or otherwise provided to the terminal. On playing the game (however obtained at the terminal), game selection values are generated at the terminal. The game selection values are uploaded to the server whereupon the promotion can be authorized to the terminal. Alternatively the promotion can be authorized at the terminal. The game can be generated or stored at the terminal as described above or from a local device such as a CD ROM, a DVD, a ROM, a tape, etc.

All prizes, discounts, etc. referred to in this specification should be construed to fall under the term “redemptions”.

It should be noted that while the above method of operation has been described with reference to the server, in case of small discounts and prizes it may be preferable to do the redemption determination at the terminal itself. In that case, the terminal may itself be considered to be equivalent to the server.

The redemptions that have been authorized should be stored in the record of the database in the server relating to the identified user, and in a global record. In addition, the time and day of the requests for redemptions can be stored in the database, so as to be able to determine busy/slow times and days, and therefore allow adjustment of the advertising campaign to best effect.

On an ongoing basis, or from time to time, an administration terminal in communication with the server should access the database, and can determine any on a global basis, on an individual user basis, on a terminal by terminal basis, or a time and day basis and on a demographic basis the success of the program, as well as the quantities and character and values of the redemptions, the ebb and flow of purchases, etc.

Thus by use of a processor operated point of sale terminal, inputting of information which is normal to a sale, and in addition inputting of information relating to a promotion if a promotion is offered, results in the ability to automatically determine the success of a promotional campaign, with regard to demographics, with regard to individuals, with regard to particular locations (since particular terminals can be identified), to determine its resulting characteristics, and to vary the values and types of redemptions which are awarded and to gather redemption values for accounting purposes. Previously this type of information could not be automatically obtained with such precision.

At the same time, since redemptions are controlled from information stored at the server rather than from printed materials at the point of sale terminal which can be fraudulently printed or misinterpreted, fraud can be reduced.

A person understanding the above-described invention may now conceive of alternative designs, using the principles described herein. All such designs which fall within the scope of the claims appended hereto are considered to be part of the present invention.

I claim:

1. A method of operating an electronic promotion system comprising:
(a) inputting at a terminal the identity of a promotion,
(b) generating an unique identifier relating to at least one of the inputting of said identity and a transaction associated with said inputting of said identity,
(c) storing the identity of the promotion and the unique identifier in a database, and
(d) authorizing provision of the promotion at the terminal,
whereby at least one of the identity of promotions, the number of requests for access to promotions and the number of promotions authorized to be redeemed may be retrieved from the database for assessment on an ongoing or accumulated basis.

2. A method as defined in claim 1 including authorizing at least one of the character and value of the promotion based on at least one of chance, a predetermined algorithm, and the existence of a predetermined fixed promotion.

3. A method as defined in claim 1 including storing a game at the terminal prior to authorizing provision of the promotion at the terminal, and on playing the game whereby game selection values are generated, authorizing the promotion based on the game selection values.

4. A method as defined in claim 1 including storing an application engine capable of generating data that can be used to create a game upon receipt of a set of instructions downloaded to the terminal, at the terminal prior to authorizing provision of the promotion at the terminal, and on playing the game whereby game selection values are generated, authorizing the promotion based on the game selection values.

5. A method as defined in claim 1 in which the identity of the requested promotion is automatically generated at the terminal.

6. A method as defined in claim 1 in which the identity of the requested promotion is automatically generated at the terminal as a generic request for access to a promotion awarding process.

7. A method as defined in claim 6 in which the generic request results from reading a card identifying at least one of a user of a promotion and of an advertiser in a card reader.

8. A method as defined in claim 1 in which the unique identifier is at least one of an identifier of the customer and an automatically generated identifier of a transaction.

9. A method as defined in claim 1 in which the identity of the promotion is a series of numbers obtained by scanning a printed bar code from a piece of promotional material or from a broadcast medium or internet site.

10. A method as defined in claim 9 including inputting the unique identifier by reading a personal identifier from a personal storage medium.

11. A method as defined in claim 10 in which the personal storage medium is at least one of a card carrying personal identification of the customer printed thereon or recorded in a magnetic strip or is a memory of an integrated circuit chip, a smart card or a personal digital assistant device or computer, and further including the step of reading the printed identification, the magnetic strip or memory of said chip, smart card or personal digital assistant device or computer by a reader associated with the terminal.

12. A method as defined in claim 8 including storing said at least one identifier at a server.

13. A method as defined in claim 12 including establishing a communication link between the terminal and the server following the inputting step.

14. A method as defined in claim 13 including generating the unique identifier by the server.

15. A method as defined in claim 1 including the step, prior to the inputting step, of providing a group of selectable promotions at the terminal, and in which the inputting step is comprised of selecting one of the selectable promotions.

16. A method as defined in claim 15 including the step, prior to the step of providing a group of selectable promotions, of identifying a customer, storing a customer identifier, and then storing the identity of the selected promotion and optionally the identity of the promotion that is authorized in relation to the customer identifier.

17. A method as defined in claim 16 in which the step of authorizing the provision of the promotion includes comparing the identity of a promotion with a stored identity and authorizing said promotion in the event of a match.

18. A method as defined in claim 17 in which the identity of a promotion is comprised of a set of numbers exposed on a scratch and win or save card.

19. A method as defined in claim 1 in which the step of authorizing the provision of the promotion includes comparing the identity of a promotion with a stored identity and authorizing said promotion in the event of a match.

20. A method as defined in claim 19 in which the identity of a promotion is comprised of a set of numbers exposed on a scratch and win card.

21. A method as defined in claim 1 including authorizing provision of said promotion by at least one of display at the terminal, providing a printout, or by audio annunciation.

22. A method as defined in claim 17 including authorizing provision of said promotion by at least one of display at the terminal, providing a printout, or by audio annunciation.

23. A method as defined in claim 16 in which the authorizing step includes automatic selection of a promotional value or authorized promotional entity on matching at least one of demographics of a customer and purchase history of a customer matching predetermined demographic or purchase categories, and authorizing said promotional value or promotional entity.

24. A method as defined in claim 21 in which the authorizing step includes automatic selection of a promotional value or authorized promotional entity on matching at least one of demographics of a customer and purchase history of a customer matching predetermined demographic or purchase categories, and authorizing said promotional value or promotional entity.

25. A method of operating an electronic promotion system comprising:
(a) at a terminal, generating a request to a promotion awarding process,
(b) receiving the request and generating a promotion based on at least one of chance, a predetermined algorithm, values input at the terminal, and the existence of a predetermined fixed promotion, and
(c) authorizing provision of the generating promotion at a terminal.

26. A method as defined in claim 25 including transmitting data embodying the request from the terminal to a server, carrying out the promotion awarding process at the server, and transmitting data embodying the authorization from the server to the terminal, and displaying the awarded promotion at the terminal.

27. A method as defined in claim 25, including storing a game at the terminal, uploading game selection values generated at the terminal to the server, and authorizing the promotions based at least partly on the game selection values from the server to the terminal.

28. A method as defined in claim 25 including providing a game to the terminal prior to authorizing provision of the promotion to the terminal, and on playing the game, uploading game selection values to the server and authorizing the promotion based on the game selection values.

29. A method as defined in claim 28 including transmitting data embodying the request from the terminal to a server, carrying out the promotion awarding process at the server, and transmitting data embodying the authorization from the server to the terminal, and displaying the awarded promotion at the terminal.

30. A method as defined in claim 29, including providing the game by one of downloading the game from the server and prestoring the game at the terminal.
